(19) United States
(12) Patent Application Publication
(10) Pub. No.: US 2015/0258893 A1
(43) Pub. Date: Sep. 17, 2015

(54) INSPECTION INTERFACE UNIT

(71) Applicant: AUTOKONTROL LIMITED, Oldham, Greater Manchester (GB)

(72) Inventor: George Malcolm Gray, Oldham (GB)

(21) Appl. No.: 14/429,383

(22) PCT Filed: Sep. 17, 2013
(86) PCT No.: PCT/GB2013/052418

§ 371 Date: Mar. 19, 2015

(30) Foreign Application Priority Data
Sep. 19, 2012 (GB) 1216739.1

(51) Int. Cl. B60K 31/00; B60W 30/14

(52) U.S. Cl. CPC B60K 31/00; B60W 30/146; B60W 2050/143

(57) ABSTRACT

Disclosed is an interface to a vehicle speed limiter system comprising: means to apply to the speed limiter system a signal indicative of the vehicle speed; a first indicator to indicate that the speed limiter system is operational at the limited speed.

The present invention relates to an inspection interface for use with a speed limiter system of the type employed in vehicles, and which limits the maximum upper speed of the vehicle.

There are certain situations where it may be desirable or even essential to limit the maximum speed of a vehicle. In some cases, certain classes of vehicle (e.g. heavy goods vehicles or road trains) are restricted to a maximum speed by statute. In other cases, the operator of the vehicle may wish to enforce a maximum speed for insurance purposes or to obtain better fuel efficiency. In any event, there is a need to limit maximum vehicle speeds in a variety of vehicles and for a variety of reasons.

There are a number of speed limiting systems which can be fitted to vehicles post-manufacture. Such systems are intended to be fitted in such a way that they can not be over-ridden by the driver of the vehicle and are, to all intents and purposes, a permanent restriction on the maximum speed which may be obtained from a particular vehicle.

However, there are documented circumstances of individual drivers acting to circumvent the speed limiting system and this can have repercussions for the owner of the vehicle. For instance, fuel efficiency may be adversely affected, insurance policies may be invalidated or the vehicle may even be in an illegal condition.

A particular problem with a speed limiter system fitted to any vehicle is that it is difficult or impossible to assess its operation when the vehicle is stationary. As such, if a vehicle is stopped by a police officer or other authorised official, there is currently no simple way for the officer to verify the correct operation of a speed limiter system, apart from actually being in the vehicle as it approaches its limited maximum speed. This is clearly impractical. Similarly, in certain countries, vehicles are required to undergo periodic testing to assess their roadworthiness. In such tests, it is not generally possible to test the vehicle at speed or on a rolling road.

There is therefore a need to provide a means to assess and monitor the operation of speed limiter systems in a vehicle without requiring the vehicle to be moving at the time of the test.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

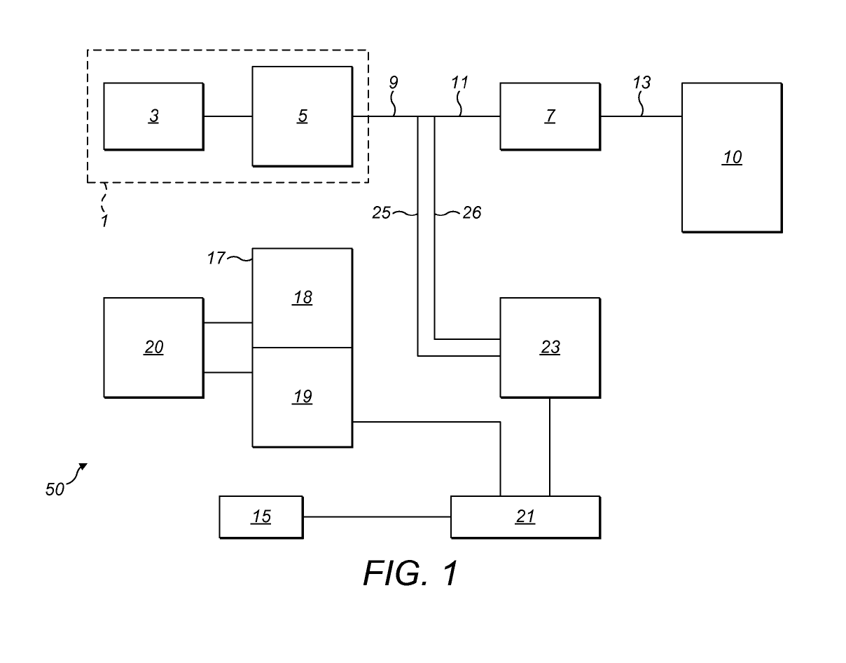

FIG. 1 shows a prior art speed limiter system;

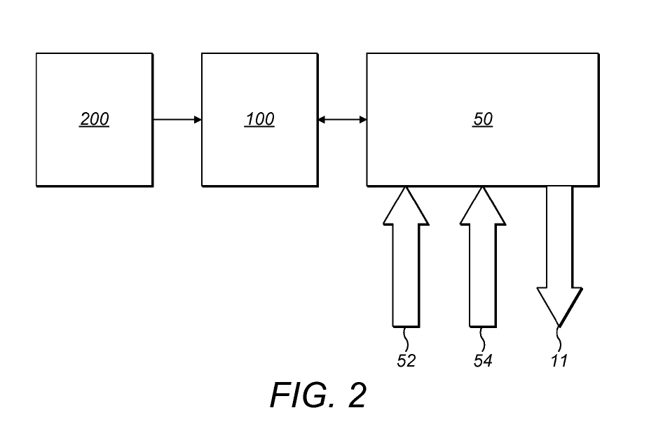

FIG. 2 shows a schematic of the speed limiter of FIG. 1 and how it interfaces with a unit according to an embodiment of the present invention; and

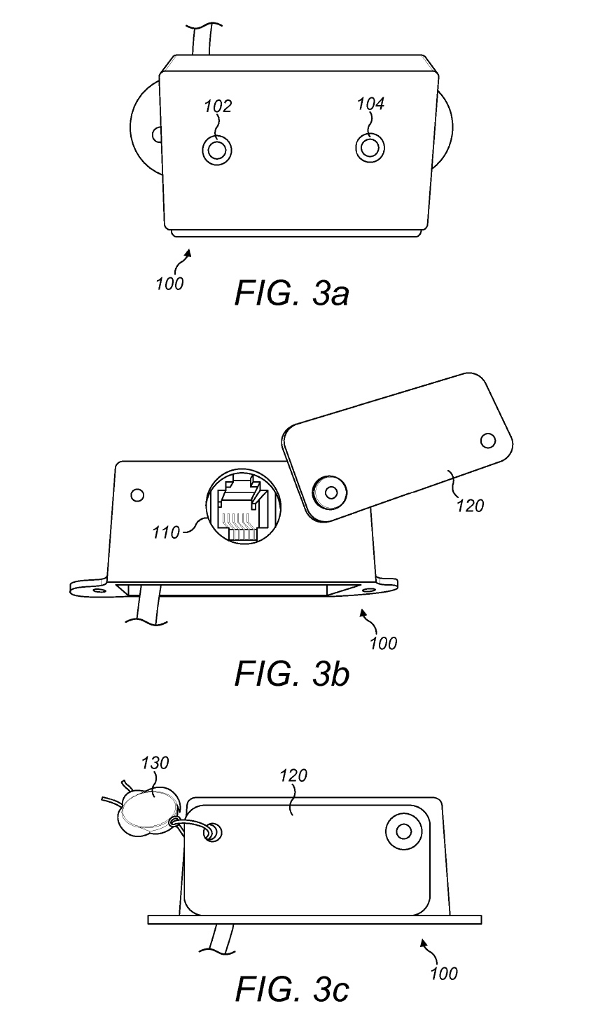

FIGS. 3a-3c show various views of an embodiment of the present invention.

A prior art speed limiter is disclosed in PCT application WO2007/132213A1. A product related to the system disclosed in that publication is the Drive by Wire (DbW) system available from Autokontrol Ltd. A block diagram of the major components of this speed limiter is shown in FIG. 1.

The speed limiter referred to is of the type that is used in so-called “drive by wire” systems, where pressure on the accelerator pedal or throttle is converted into an electrical signal which is passed to an engine management system and the magnitude of the signal corresponds to a desired speed. In response to a signal indicative of the vehicle speed, the speed limiter acts to limit the maximum voltage which is passed to the engine management system and so the maximum speed of the vehicle is limited accordingly.

As a very simple example, suppose that the voltage produced from the throttle signal is normally in the range 0-10V. The speed limiter in question receives a signal from a speed sensor and once the set maximum speed is neared or reached, the speed limiter system is operable to ‘clamp’ the voltage such that it may not exceed the present voltage, meaning that the speed of the vehicle cannot increase. This, therefore, has the effect of restricting the maximum speed achievable.

Other forms of speed limiters operate on the more traditional cable-linked throttle systems and, although the method of control operated on the engine to limit the maximum speed differs from the drive by wire system referred to herein, they too can benefit from embodiments of the present invention.

The system 50 shown in FIG. 1 is a “drive-by-wire” type system in which an electromechanical throttle (1) controls the speed of an engine (10) (and hence a vehicle) via an electronic signal transmitted through and processed by an engine management system controller (7) which includes at least an engine speed controller.

Ultimate user control is effected by actuation of a mechanical throttle actuator (3), which in this typical example comprises an accelerator/gas foot pedal mounted within a vehicle cabin to be accessible by and operable by the driver. The mechanical actuator (3) is mounted in conjunction with a throttle signal generation means (5) which generates an electronic throttle signal corresponding to the extent to which the mechanical actuator is operated. In the present example, depression of the accelerator pedal operates in conjunction with a pair of potentiometers to generate a functionally related electronic throttle signal corresponding to the extent to which the pedal is depressed.

The resultant electronic throttle signal is passed via the data communication (9) and transmitted via the data communication (11) to an engine management system computer (7) which includes at least an engine speed controller. Where the speed limiter components are not operating, the generated signal (9) corresponds to the transmitted signal (11), and the latter is processed by the engine speed controller and used to control the speed of the engine (10) via the data link (13).

A pair of potentiometers is used in the example (not shown) in the signal generation system (5) to give a degree of redundancy for safety. A pair of throttle signals is thereby generated, each signal being transmitted to and processed separately by the engine management system. In the event that the signals essentially correspond, within a pre-set safety margin, that is taken as the intended throttle signal, and the system operates accordingly. In the event that there is an excessive differential between the signals in the pair, which is likely to arise for example if there is a fault with one of the potentiometers or its corresponding data link, the engine management system will be designed to detect this as a fault. It might then refuse to operate the throttle system, or to operate the throttle system only in a safe mode (for example applying a predetermined limit), until the fault can be rectified.

To the above extent, the throttle is essentially a conventional drive-by-wire throttle system. However, the schematic example illustrates such a throttle system modified, either by prior manufacturer's design or as an after market fitment, with a speed limiter system in accordance with the invention.

The speed limiter system first includes a speed sensor (15). Again, for practical purposes, this is likely to make use of an existing speed sensor within the vehicle, for example provided within the transmission system or braking system, although a specific additional speed sensor could alternatively be provided. The speed sensor will normally be such as to sense, directly or indirectly, the vehicle speed, since it is this that it is ultimately the intention of the system of the invention to limit. For example the speed sensor (15) is fitted to and takes a signal from a vehicle speedometer and thus senses vehicle speed indirectly by taking a direct reading of the rotational speed/frequency of the transmission shaft.

Additional sensors may be provided for example to limit engine speed (for example to set a maximum engine revolutions rate) and the skilled person would readily appreciate that these additional sensors could similarly be incorporated into a limiter system of the invention with minimal trivial further modification. However, they are not directly pertinent to the present invention, which is primarily a means to limit vehicle speed a predetermined limit and, in the present illustrative embodiment, to one of at least a pair of predetermined maximum speeds, being a normal road speed and an off-road speed.

Maximum speeds are set in the data store (17). The data store (17) in this embodiment includes at least a first data register (18) including at least two locations in which separate maxima relating to normal road and rough terrain conditions can be stored, and a second register (19) which is intended to store the currently operable maximum speed. The different maximum speeds stored in the data register (18) may be hard stored or may be user settable. In the case of user settable limits, a suitable data input means, for example comprising a keypad or the like (not shown) may be provided.

In the embodiment, two limit speeds are stored, and selection between them is effected automatically in the manner below described using a vibration sensor. This is an illustrative example only. A data register may provide for the storage of a single limit speed only. Multiple limit speeds may be stored for other reasons. If multiple limit speeds are stored, selection between may be made in other ways either automatically in accordance with some predetermined or sensed condition or by a user selection action.

In the illustrated embodiment, selection between the two limit speeds, and the choice of which limit speed is to be stored in the register (19) as the currently operable maximum speed is effected by a vibration monitor system which is intended to be of a sensitivity such as to detect whether the vehicle is on or off road. The vibration monitor system (20) includes a vibration sensor such as a trembler switch, and suitable electronic control means which determine conditions under which the switch is considered to be tripped, as a result of which a different limit is selectively to be applied. The vibration monitor system (20) reads the limits from the first data register (18) via the communication link, determines which of these limits is operable based on its vibration state, and applies this in the applied data register (19) via the communication link. Thus, where such vibration conditions as are necessary to register with the trembler switch control means are complied with, an appropriate lower speed limit is passed from the data store (18) to the applied register (19) and in the event such vibration conditions are not complied with, an appropriate higher speed limit is passed to the applied data register (19). It is of course possible without departing from the principles of the invention to have a vibration system sensitive to several discrete degrees of vibration, and to apply several different limit speeds correspondingly.

The purpose of these varied limits is to set a different maximum speed for road and off-road conditions. A number of vehicles, in particular large, heavy vehicles such as trucks, are specifically designed for heavy operation both on and off road. Maximum speeds which might be set by a regulatory regime or otherwise as suitable for paved roads, are entirely inappropriate for use off such a road, for example on a roughly made site road. The system of the invention applies a different maximum speed dependent upon the roughness of terrain.

The speed to be applied by the system is stored in the applied data register (19). A comparator (21) is in data communication with and reads both the detected speed at the speed sensor (15) and the stored applicable limit speed in the data register (19). The comparator (21) acts in conjunction with a throttle signal modifier unit (23) to tend to modify the signal transmitted via the data link (11) to the engine speed management system so as to limit the vehicle speed to the pre-set speed.

This modification is effected via the data links (25, 26). Via the input data link (25) the throttle signal modifier unit (23) receives a throttle signal (9) generated by the throttle assembly (3, 5). At below limit speed this is passed on via the output data link (26) unmodified as a transmitted signal (11) identical to the generated signal (9). If the limit is reached the throttle signal modifier unit (23) blocks direct transmission of and modifies the generated signal (9) so as to produce a different transmitted signal (11) read by the engine speed management system (7).

The engine speed management system is “fooled” into receiving a transmitted signal (11) which corresponds to an apparent level of throttle actuation that tends to limit the speed to, and bring the vehicle speed within, the limit speed. In the specific example, where the throttle signal is generated by a pair of potentiometers, the throttle signal modifier (23) acts via the data links (25, 26) to draw off some of the potential generated by the potentiometers and thus cause the apparent signal (11) received by the engine management system to appear to correspond to a depression of the accelerator which would limit the engine speed, and hence vehicle speed, to the desired limit.

FIG. 2 shows a schematic of an embodiment of the present invention, and its interaction with a speed limiter system 50. The speed limiter is installed in a vehicle, usually in a relatively inaccessible location, such as behind the dashboard or in the engine compartment. At the time of installation, the necessary signal wires and power are connected and then the unit is sealed and left to operate. In order to provide the inspection interface according to an embodiment of the present invention, an extension unit is coupled to the speed limiter and the extension unit is fitted on the dashboard or another accessible and visible part of the vehicle.

The speed limiter 50 has two major inputs from the vehicle: power 52 and the speed signal 54, which is derived from speed sensor 15. The speed limiter 50 has an output 11, which is passed to the ECU 7 or, in other forms of speed limiter, to some other form of control mechanism.

FIG. 3a shows a front view of the extension unit 100, which incorporates the inspection interface, and FIG. 3b shows a lower view, with the connector accessible. In FIG. 3a, can be seen a pair of indicator lights. The first indicator light 102 is arranged to illuminate when the speed limiter is powered up. The second indicator light 104 is arranged to illuminate when the maximum speed is reached and provides a visual indication to the driver that the speed limiter is operating correctly. The indicator lights are suitably LEDs, with the first 102 preferably being coloured green and the second 104 being coloured red. Operation of the second indicator light may be combined with an audible indication to alert the driver that the maximum speed has been reached.

On a lower face of the extension unit 100, there is provided an electrical connector 110 which allows a test unit 200 to be connected to the speed limiter system. The electrical connector 110 may be located behind a moveable plate 120, provided with a tamper seal 130, such as a meter seal, of the form comprising a loop of wire and a crimped lead token. In cases where speed limiter systems are fitted to comply with a relevant statute, then the entire system is required to be sealed so that any attempted tampering can be detected.

Once the plate 120 (if fitted) is moved out of the way, an electrical socket 110 is revealed, into which may be connected the custom test unit 200. The test unit is able to simulate the signal 54 created by the vehicle speed sensor 15 and apply this to the speed limiter 50. Therefore by adjusting the signal which is applied to the speed limiter via the inspection interface, it is possible to mimic vehicle motion and so fool the speed limiter into sensing vehicle motion.

In order to assess the true operation of the speed limiter, the test unit 200 is set to produce a speed signal which is very near to the maximum limited speed. Then, with the vehicle engine running, but with the gears set to neutral, the throttle is depressed to increase the engine revs. The speed limiter 50 senses an increase in the throttle voltage and, thinking that the maximum speed is very near, starts to reduce the throttle voltage so that the maximum speed cannot be exceeded. This it will be very obvious to the tester that the engine revs are being decreased even with increased throttle pressure. In this way, the correct operation of the speed limiter system can be tested and verified. If the system has in any way been tampered with such that it is inoperational, the revs will continue increasing, unaffected by the speed limiter system.

This has the advantage that it is possible to test the operation of the speed limiter whilst the vehicle is stationary. In order to test prior art speed limiter systems, it would generally be necessary to do so while the vehicle was in motion at or near the maximum limited speed. This is not always possible or desirable and so embodiments of the present invention allow a straightforward way of verifying the operation of the system, which may be a statutory requirement in some countries or regions.

It has been found that in some prior art systems, attempts are made to circumvent the speed limiter system and in some cases deliberate attempts are made to damage it, so as to defeat it. Embodiments of the present invention are protected so that attempts to damage the speed limiter by, for instance tampering with the contacts of the electrical connector 110 or attempting to apply a voltage to one or more contacts may be rendered harmless and ineffective.

The interface to the speed limiter system is protected by use of a so-called polyswitch. This is a resettable device which operates like a fuse in over current situations and so isolates the speed limiter system from the interface unit 100. However, when the polyswitch cools down and reverts to a normal temperature, it rests and normal operation is again possible.

By means of the simple plate 120, the connector 110 is shielded in normal use and allows a degree of addition security and also allows the unit 100 to comply with statutory tamper-proofing rules in certain jurisdictions. The plate 120 is arranged to pivot to open and is sealed with a meter seal 130. Similar tamper-proofing systems are employed with electricity and gas meters and meters in taxi cabs.

Embodiments of the present invention allow a simple and reliable means to determine the operational status of a speed limited without requiring the vehicle to be in motion at the time of the test. Advantageously, the interface is protected against attempts to defeat the speed limiter system and is also provided with a visible mean of identifying any tamper attempts.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A vehicle speed limiter for use with a vehicle throttle system comprising a mechanically actuatable throttle member, an engine speed controller, and a throttle signal unit in data communication with the engine speed controller and operably coupled to the throttle member so as to generate an electronic throttle signal in functional response to the degree of actuation of the throttle member, and to transmit a throttle signal to the engine speed controller whereby the engine speed is controlled; the vehicle speed limiter comprising: a vehicle speed sensor to obtain a signal indicative of vehicle speed; a limit speed data register including a data store for a limit speed data item indicative of at least a first predetermined limit speed; a comparator to compare the speed sensor output with the limit speed data item stored in the limit speed register; and a throttle signal modifier unit acting on the output of the throttle signal unit in use when fitted in conjunction with a vehicle throttle system to modify a generated throttle signal so that a transmitted throttle signal is produced such as to tend to limit the vehicle to the applied limit speed.

2. A vehicle speed limiter in accordance with claim 1 wherein the throttle signal modifier unit is adapted for attachment in use in data communication between the throttle signal unit and the engine speed control unit in that it includes an input in data communication with the throttle signal unit to receive an input signal comprising an unmodified throttle signal from the throttle signal unit and an output in data communication with the engine speed control unit to output a throttle signal thereto which is optionally modified as above described.

3. A vehicle speed limiter in accordance with claim 1 wherein the speed sensor is adapted to make use of an existing vehicle system allowing for the sensing of speed.

4. A vehicle speed limiter in accordance with claim 3 wherein the speed sensor is adapted for fitment to the vehicle speedometer system to obtain a reading of speed therefrom.

5. A vehicle speed limiter in accordance with claim 1 adapted for use with a throttle signal unit including an electronic signal generator configured such that a varying voltage electronic signal is in inherently produced as the throttle member is operated to a varying extent, wherein the signal modifier unit is able to modify the generated electronic signal in that it is electrically connected to the electronic signal generator so as to be able to pull the generated voltage lower than it would otherwise be set to by the operation of the throttle member without operation of the speed limiter.

6. A vehicle speed limiter in accordance with claim 1 adapted to operate continuous successive cycles of speed sensoring and throttle signal modification as necessary.

7. A vehicle speed limiter in accordance with claim 6 including speed limit control means adapted to effect such successive monitoring, and further adapted to apply a proportional control technique wherein, as the comparator detects that the limit speed is approached to a certain predetermined degree of closeness, the signal modifier begins to apply a signal modification which becomes stronger the near the vehicle comes to the limit speed.

8. A vehicle speed limiter in accordance with claim 1 wherein the throttle signal modifier unit includes a switching control unit which acts to pass an unmodified throttle signal when the comparator indicates that vehicle speed is below the limit speed, but acts to block the unmodified signal and/or transmit on a modified signal that tends to hold the vehicle at the limit speed when the comparator indicates that the limit speed has been reached or is being approached.

9. A vehicle speed limiter in accordance with claim 1 including input means to allow a user to input or vary the limit speed before use.

10. A vehicle speed limiter in accordance with claim 1 adapted to allow for the storage of a plurality of limit speeds, and to allow a user to switch between limit speeds and to allocate a limit speed to be applied selectively in that the data register includes a register to store a plurality of limit speeds, and an applied limit speed register to store a speed to be applied, and a means is provided to select for storage in the applied speed limit register one of the said stored limit speeds.

11. A vehicle speed limiter in accordance with claim 10 modified to provide a first limit speed and a second limit speed selected as to be appropriate limits respectively for off and on road conditions and further comprising a vibration sensor of a suitable sensitivity to tend to be actuated in off road conditions but not in driving conditions typically encountered on paved roads to effect automatic switching between the two limit speeds.

12. A vehicle speed limiter in accordance with claim 11 wherein the limiter system comprises a data register to store at least a first limit speed and a second limit speed, and an applied limit speed register to store one such limit speed as an applied limit speed; a vibration sensor and vibration control means configured such that the applied speed is set to the first limit speed below a vibration threshold level and to the second limit speed above a vibration threshold level; a vehicle speed sensor to output a signal indicative of vehicle speed; a comparator to compare the speed sensor output with the limit speed in the applied limit speed register; a throttle system modifier acting on the output of the throttle signal unit in use when fitted in conjunction with a vehicle throttle system as above to modify the generated throttle signal so that the transmitted throttle signal is such as to tend to limit the vehicle to the applied limit speed.

13. A vehicle throttle and engine speed control system comprising a mechanically actuatable throttle member; an engine speed controller; a throttle signal unit in data communication with an engine speed controller and operably coupled to the throttle member so as to generate an electronic throttle signal in functional response to the degree of actuation of the throttle member, and to transmit a throttle signal to the engine speed controller whereby the engine speed is controlled; and a vehicle speed limiter in accordance with claim 1.

14. A vehicle fitted with a vehicle throttle and engine speed control system in accordance with claim 13.

15. A method of fitment of a vehicle speed limiter to a vehicle having a throttle system comprising a mechanically actuatable throttle member, an engine speed controller, and a throttle signal unit in data communication with the engine speed controller and operably coupled to the throttle member so as to generate an electronic throttle signal in functional response to the degree of actuation of the throttle member, and to transmit a throttle signal to the engine speed controller whereby the engine speed is controlled, the method comprising the fitment of a vehicle speed limiter in accordance with claim 1 such that the throttle system modifier is configured to be able to act to modify a generated electronic throttle signal.

16. The method of claim 15 comprising fitting a vehicle speed sensor to obtain a signal indicative of vehicle speed; fitting a control unit in data communication therewith comprising a limit speed data register to include a data store for at least a first predetermined limit speed, a comparator to compare the speed sensor output with the limit speed stored in the limit speed register, and a throttle system modifier unit; wherein the throttle signal modifier unit is fitted in data communication with and able to act directly upon on the output of the throttle signal unit when so fitted to modify the generated throttle signal so that a throttle signal transmitted to the engine speed controller is such as to tend to limit the vehicle to the applied limit speed.
